(19) United States
(12) Patent Application Publication
(10) Pub. No.: US 2025/0383570 A1
(43) Pub. Date: Dec. 18, 2025

(54) IMAGE-PROJECTION DEVICE WITH REFLECTION USING ELECTROCHROMIC MATERIAL

(71) Applicant: VALEO VISION, Bobigny (FR)

(72) Inventors: Eduardo ALVEAR, Bobigny (FR); Sidahmed BEDDAR, Bobigny (FR); Ali KANJ, Bobigny (FR)

(73) Assignee: VALEO VISION, Bobigny (FR)

(21) Appl. No.: 18/875,812

(22) PCT Filed: Jun. 30, 2023
(86) PCT No.: PCT/EP2023/068113

§ 371 Date: Dec. 17, 2024

(30) Foreign Application Priority Data
Jun. 30, 2022 (FR) FR2206667

(51) Int. Cl. G02F 1/163; B60Q 1/24; G02F 1/157

(52) U.S. Cl. CPC G02F 1/163; B60Q 1/247; G02F 1/157

(57) ABSTRACT

The invention relates to an image projection device. The image projection device including a luminous source for emitting light rays, an image formation module including a reflection assembly which is able to reflect light rays from the luminous source as a reflected beam, an optical projection system which is placed in the path of the reflected beam and is able to project an image formed by the image formation module. The reflection assembly includes a multilayer structure including a substrate, a metal layer and a layer of electrochromic material including at least one cell, the at least one cell being encapsulated in an electrolyte layer and connected to a pair of electrodes. The image projection device further includes an electrical control circuit which is able to vary a voltage applied to the pair of electrodes so as to vary a color of the at least one cell.

### TECHNICAL FIELD

The technical field of the invention is that of image projection devices and, more specifically, those equipping automotive vehicles and allowing images to be projected onto the ground.

### BACKGROUND OF THE INVENTION

Such devices, sometimes called “dynamic carpet projectors” (adjustable ground projectors), currently exist, allowing images to be projected onto the ground when a door is opened or unlocked, or when a door is approached, when the driver brings a key or a fob for opening the vehicle closer.

Such a device comprises a light source, generally a light-emitting diode, which produces an illuminating light beam, shaped by an illumination or collimation lens placed downstream of the source, between the source and the image to be projected. The image to be projected transmits or reflects, according to the technology used, the illuminating light beam toward an optical projection system, which projects the image onto the ground.

The image to be projected may be produced using various technologies. For example, an array of micromirrors (or DMD for digital micromirror device) may be used. This technology has the drawback of creating hotspots inside the device and is therefore not robust from a thermal point of view. Also, an array of microLEDs may be used, but problems of heat dissipation are also encountered. A third technology is that using laser scanned microelectromechanical systems (“laser scanned MEMS”). The latter technology is emergent and is not robust against mechanical vibrations.

### SUMMARY OF THE INVENTION

The invention offers a solution to the problems mentioned above, by proposing an alternative technology for producing the image to be projected.

A first aspect of the invention relates to an image projection device comprising:
a luminous source for emitting light rays,
an image formation module comprising a reflection assembly which is able to reflect light rays from the luminous source as a reflected beam,
an optical projection system which is placed in the path of the reflected beam and is able to project an image formed by the image formation module.

The reflection assembly comprises a multilayer structure comprising a substrate, a metal layer and a layer of electrochromic material comprising at least one cell which is encapsulated in an electrolyte layer and connected to a pair of electrodes, the image projection device furthermore comprising an electrical control circuit which is able to vary a voltage applied to the pair of electrodes so as to vary a color of said at least one cell.

Thus, by virtue of the invention, it is possible to project an image onto the ground without any hotspot or heat dissipation problem and without any robustness problem.

According to a first embodiment, the layer of electrochromic material can comprise a single cell and the image formation module can furthermore comprise at least one mask positioned between the reflection assembly and the optical projection system, said mask being able to produce a pattern of the image formed by the image formation module.

Thus, it becomes possible to vary the color of the projected pattern by controlling the voltage applied to the single cell, the pattern being determined by the mask. It thus becomes possible to produce a dynamic projection, at least by varying the color, without any hotspot, heat dissipation or robustness problem.

In addition, the image formation module can comprise a set of multiple masks, and the electrical control circuit may be able to select one of the masks of the set for producing the pattern of the image formed by the image formation module.

Thus, it becomes possible to vary the projected image, both in terms of its color and also in terms of the projected pattern. It thus becomes possible to project varied images or to produce luminous animations.

Alternatively, according to second and third embodiments, the reflection assembly can comprise a plurality of pixels, each pixel being formed by at least one cell and being connected to at least one pair of electrodes, the electrical control circuit being able to independently vary the voltage applied to said at least one pair of electrodes of each pixel.

It thus becomes possible to project pixelated images by reflection using a layer of electrochromic material, which has the advantages of not posing a heat dissipation problem, of allowing a high level of robustness and a smaller bulk compared to the solutions of the prior art.

In addition, each pixel of the plurality of pixels can have a length and a width of between 50 and 500 micrometers, in particular between 70 and 150 micrometers.

It thus becomes possible to project a high resolution image with a smaller bulk of the image projection device.

According to the second embodiment, each pixel can be formed by a single cell and is connected to a single pair of electrodes.

Thus, the control of the color of each pixel is determined directly by the voltage applied to the corresponding cell, thereby simplifying the control of the projected image.

According to the third embodiment, each pixel can be formed by a plurality of cells and, for each pixel, the plurality of cells can comprise at least a first set of at least one cell and a second set of at least one cell, the first set being connected to a first pair of electrodes and the second set being connected to a second pair of electrodes, and the electrical control circuit may be able to vary the color of each pixel by varying a first voltage of the first pair of electrodes and a second voltage of the second pair of electrodes.

Thus, the color of a pixel is obtained by synthesizing colors of cells that make up the pixel. It thus becomes possible to project color images with a wide range of colors.

In addition, for each pixel, the first set can comprise multiple cells and the second set comprises multiple cells.

Thus, the control of the color of each pixel is simplified compared to cell-by-cell control. There is in particular the possibility of producing smaller-sized cells and therefore of reducing the bulk associated with the image projection device.

According to embodiments, the electrochromic material can be chosen from PEDOT, PMMA or polycarbonate.

Such materials are electrochromic, are robust and have lower costs compared to the solutions of the prior art.

A second aspect of the invention relates to a method for controlling an image projection device according to the first aspect of the invention, the method comprising the following steps:
receiving a setpoint by way of the electrical control circuit;
determining a voltage to be applied to each pair of electrodes on the basis of said setpoint;
applying, for each pair of electrodes, said voltage by way of the electrical control circuit.

The invention and its various applications will be better understood upon reading the following description and upon studying the accompanying figures.

### BRIEF DESCRIPTION OF DRAWINGS

The figures are presented for information and in no way limit the invention:

FIG. 1 schematically shows a side view of a vehicle equipped with an image projection device according to embodiments of the invention;

FIG. 2 schematically shows an image projection device according to embodiments of the invention;

FIG. 3 schematically shows a reflection assembly comprising a multilayer structure according to embodiments of the invention;

FIG. 4 shows a reflection assembly of an image projection device according to embodiments of the invention;

FIG. 5 illustrates the dependency of the wavelength reflected by a layer of electrochromic material illuminated by a wide-bandwidth beam on the thickness of this layer;

FIG. 6a illustrates a front view of a reflection assembly of an image projection device, according to a first embodiment of the invention;

FIG. 6b illustrates a front view of a reflection assembly of an image projection device, according to a second embodiment of the invention; and

FIG. 6c illustrates a front view of a reflection assembly of an image projection device, according to a third embodiment of the invention.

### DETAILED DESCRIPTION OF THE INVENTION

The figures are presented by way of non-limiting indication of the invention. Unless stated otherwise, the same element appearing in different figures is provided with a single reference.

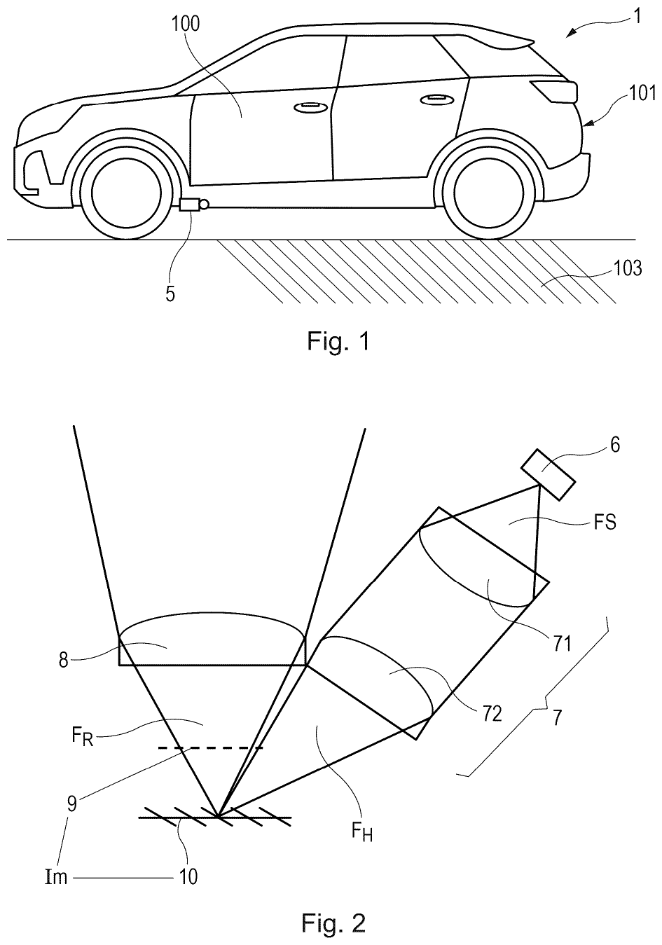

FIG. 1 shows an automotive vehicle 1 equipped with an image projection device 5 for projecting an image 103 onto the ground. The device 5 can be controlled by opening a front or rear door 100, or another hatch such as the trunk 101.

The device 5 is placed at the bottom of the body, where the height is limited and the environment is aggressive (water spray, risk of impact with elements on the road, etc.). Therefore, it is protected by a small housing (since the device is 20 cm to 30 cm from the ground), for example, with sides of 4 to 10 cm. The housing is more compact in size than the housings of the prior art due to the technology used in the present invention. Alternatively, the device 5 may be placed in a rear-view mirror.

FIG. 2 schematically shows the image projection device 5 according to the invention.

The image projection device 5 comprises a luminous source 6 for emitting a source beam Fs. Advantageously, as will be seen hereinafter, the source beam Fs has a wideband emission spectrum. Typically, the source beam Fs is a beam of white light. The luminous source 6 is a light-emitting diode, for example. In another example, the luminous source 6 is a laser source.

The device 5 also comprises an optional optical luminous system 7, and an image formation module Im.

The luminous source 6 is positioned so as to illuminate the optical luminous system 7. The optical luminous system 7 here comprises a collimator 71 and a condenser 72. The optical luminous system 7 allows the source beam Fs to be shaped, in particular transformed into a beam referred to hereinafter as a homogeneous beam FH. The optical luminous system 7 is placed downstream of the luminous source 6, between the luminous source 6 and the image formation module. The image formation module Im, which will be described hereinafter, comprises at least one reflection assembly 10 which is able to reflect the homogeneous beam FH as a reflected beam FR.

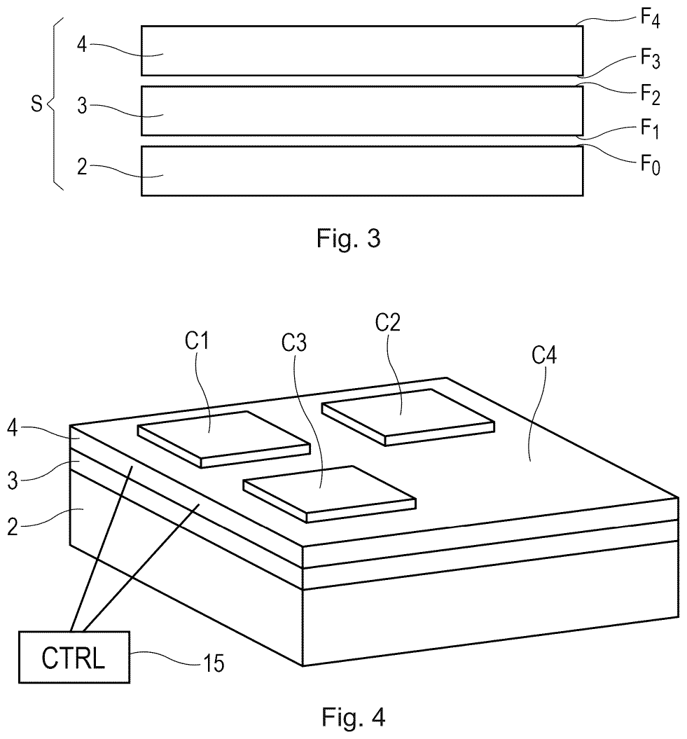

The reflection assembly 10 according to the invention comprises at least one cell having a multilayer structure described with reference to FIG. 3.

The device 5 also comprises an optical projection system 8 designed to project the image to be projected which is formed by the image formation module 1 m onto the ground from the automotive vehicle 1. The optical projection system 8 is located in the path of the reflected beam FR, downstream of the image formation module for forming an image to be projected 1 m. The optical projection system 8 typically comprises one or more lenses. Preferably, the image formed by the image formation module Im is positioned in the object focal plane of the optical projection system 8.

The optical projection system 8 forms an image 103 on the ground of the image to be projected, with very high magnification, and, in general, an expansion effect. Indeed, the sides of the image 103 formed on the ground are at least 0.5 m, and the image can even occupy an area that is 1 m long by 1 m wide or more, and the ground is illuminated at an oblique angle by the image projection device.

One of the special features of the invention lies in the reflection assembly 10, which comprises a multilayer structure S, shown schematically in FIG. 3, composed of the stack of a substrate 2, which may be flexible, of a metal layer 3 and of a layer of electrochromic material 4.

For example, the flexible substrate 2 is an organic material made of silicone, polycarbonate or PMMA. The substrate 2 has, for example, a thickness of approximately 500 microns.

The metal layer 3 is delimited by a first face F1 and a second face F2. The first face F1 is in contact with a face F0 of the flexible substrate 2. For example, the metal layer 3 may be made of aluminum, chromium or gold. The metal layer 3 has, for example, a thickness of between 70 and 100 nm.

The layer of electrochromic organic material 4 is delimited by a third face F3 and a fourth face F4. Electrochromic means a material that changes color when a voltage is applied to it for a short period of time. The material retains the new color after the voltage has been applied, but may return to its original state after a voltage of opposite sign is applied. The third face F3 is in contact with the second face F2. For example, the electrochromic organic material is PEDOT (poly(3,4-ethylenedioxythiophene)). Other examples of electrochromic material that can be used are 2-alkylthieno[3,4-b]thiophene (T34bT), PMMA or polycarbonate. The layer of electrochromic material 4 has, for example, a thickness of between 75 and 300 nm.

The layer of electrochromic material 4 here may be structured into N cells or elements, N being an integer greater than or equal to 1.

When N is greater than or equal to 2, the reflection assembly 10 may comprise multiple pixels, each pixel being formed by at least one of the N cells. The reflection assembly 10 then comprises N pixels or fewer than N pixels.

A portion of the multilayer structure with N cells C1, C2, C3, . . . and CN is shown in FIG. 4, with N equal to 4. For example, the layer of electrochromic material 4 is structured into an array of N cells.

Each cell among the N cells can be encapsulated in an electrolyte solution or gel, to which is connected a pair of electrodes intended to voltage bias the corresponding cell. Alternatively, when each pixel comprises multiple cells according to the third embodiment described hereinbelow, a set of multiple cells can be encapsulated in an electrolyte solution or gel so as to be connected to one and the same pair of electrodes.

The size of each cell depends on the embodiment being considered, three embodiments being described hereinbelow.

The N cells are encapsulated and arranged and the corresponding pairs of electrodes are arranged on each cell or set of cells in a similar manner to a liquid crystal sheet.

All of the pairs of electrodes are connected to a low voltage battery, and connected to an electrical control circuit 15 connected to the electrical system of the vehicle.

The way in which the color of one cell among the N cells of the layer of electrochromic organic material 4 is controlled is described below. Such a cell acts as a Fabry-Pérot cavity formed by the corresponding portion of the third face F3 and the corresponding portion of the fourth face F4. This cavity produces, from the light it receives, interference of a given wavelength. This interference results in multiple reflections of colored rays propagating in the opposite direction to the rays received from the luminous source 6. It is thus by a phenomenon of interference, and not of absorption as when pigments or dyes are used, that the cell produces, for an observer, a coloration.

In the present invention, the light received by the N cells may originate from the homogeneous beam FH or may originate directly from the luminous source 6.

Typically, the electrochromic material reflects between 60% and 90% of the light that it receives. For example, the luminous source, when it is a white light-emitting diode, has a flux of 400 lumen, the material thus reflecting between 240 lumen and 360 lumen.

As indicated above, the source beam Fs emitted by the luminous source 6 preferably has a wideband emission spectrum. Thus, the range of wavelengths, in other words the range of colors, that can be reflected by the electrochromic material is wider.

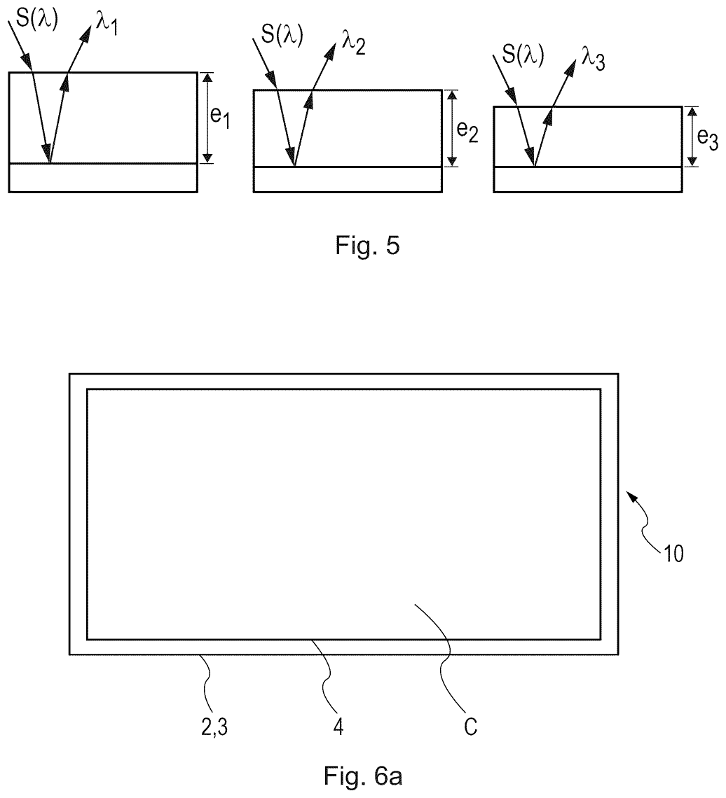

The thickness of the layer of electrochromic organic material 4 has an influence on the color perceived by an observer. For example, as shown in FIG. 5, a PEDOT layer of thickness e1 equal to 800 nm, on receiving light with a wideband light spectrum S(λ), produces, by reflection, a red color of wavelength λ1, a PEDOT layer of thickness e2 equal to 600 nm, on receiving light with a wideband light spectrum S(λ), produces, by reflection, a green color of wavelength λ2, a PEDOT layer of thickness e3 equal to 500 nm, on receiving light with a wideband light spectrum S(λ), produces, by reflection, a blue color of wavelength 3.

For example, the N cells of the layer of electrochromic organic material 4 can have different thicknesses so as to adjust their color when no voltage is applied to them.

Alternatively, all of the cells have the same thickness and the control of the color that they return is made possible by the voltage that is applied to each of the cells or to each set of cells.

The electrical control circuit 15 makes it possible to control the voltage across the terminals of the N cells of the layer of electrochromic organic material 4. A table of correspondence between the desired color and the voltage to be applied across the terminals of a pair of electrodes makes it possible to voltage control the change of color of a cell or a set of cells. The table of correspondence depends on the electrochromic organic material used. For example, the voltage across the terminals of a pair of electrodes varies between a minimum voltage of −10 volts and a maximum voltage of +10 volts.

A single pair of electrodes connected to the electrical control circuit 15 has been shown in FIG. 4, for the sake of simplicity.

Thus, the electrical control circuit 15, by receiving a setpoint, can be used to control the voltage across the terminals of each pair of electrodes in order to control the color of the corresponding cell or of the corresponding set of cells.

The image to be projected is thus formed from at least the set of N pixels whose color is controlled by the application of a voltage, in the second and third embodiments described below. In a first embodiment with a single cell, only the color of the image to be projected is controlled by the reflection assembly 10, a pattern of the image being formed by means of the mask 9 placed between the reflection assembly 10 and the optical projection system 8.

The image to be projected is thus personalizable.

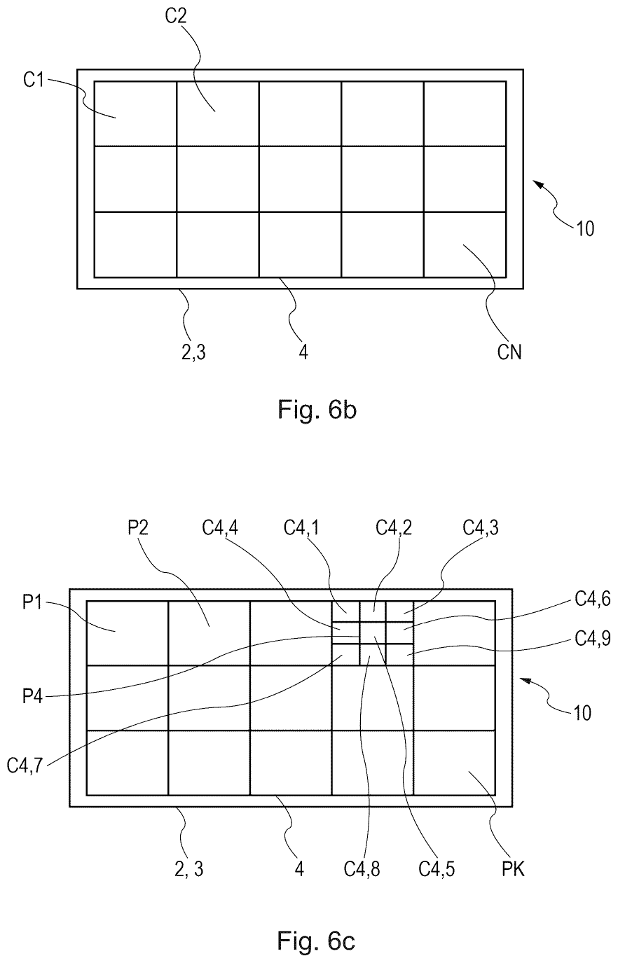

FIG. 6a shows a front view of a reflection assembly 10 of a device 5 according to a first embodiment of the invention.

According to the first embodiment, the layer of electrochromic material 4 comprises a single cell C. The electrical control circuit 15 is able to control the voltage of the single cell C in order to vary the color of the light reflected by the single cell C.

In the first embodiment, the reflection assembly 10 with a single cell is advantageously combined with the mask 9 so as to form the image formation module Im. The pattern of the image to be projected is thus produced by means of the mask 9 placed to intercept in the reflected beam FR, between the reflection assembly 10 and the optical projection system 8, while the color of the image to be projected is determined by the voltage applied by the electrical control circuit 15 to the single cell C.

It should be noted that the mask 9 may be a single mask, or a set of masks. The electrical control circuit 15 may in particular select, by way of a control signal, the mask among the set of masks that is placed to intercept between the reflection assembly 10 and the optical projection system 8. It thus becomes possible to vary the pattern and the color of the image to be projected. The masks of the set may be distributed in a circular manner, and the application of a given rotation to the set can allow the electrical control circuit 15 to select one of the masks of the set.

There is no restriction attached to the dimensions of the single cell C, in particular to the width and the length of the cell C, that is to say to the dimensions shown in the front view of FIG. 6a.

As FIG. 6a shows a front view, the substrate 2 and the metal layer 3 are only partially visible. Alternatively, the substrate 2 and the metal layer 3 have the same length and width dimensions as the single cell C, in which case the substrate 2 and the metal layer 3 are not visible in FIG. 6a.

FIG. 6b shows a reflection assembly 10 of a device 5 according to a second embodiment of the invention.

In the second embodiment, the layer of electrochromic material 4 of the reflection assembly 10 comprises an array of N cells C1 to CN, each cell being driven individually by a voltage that is applied thereto by the electrical control circuit 15, and each cell thus forming a pixel.

In the second embodiment, the reflection assembly therefore comprises N individually drivable pixels, and the resolution of the image formed is therefore equal to N.

Thus, the second embodiment can be used to project a pixelated color image from a reflection assembly 10 using a layer of electrochromic material 4.

There is no restriction attached to the dimensions of each cell C1 to CN, in particular to the width and the length of each cell C1 to CN, that is to say to the dimensions shown in the front view of FIG. 6b.

For example, each cell may have a width and a length of between 50 and 500 micrometers, for example of between 50 and 200 micrometers, and in particular of between 70 and 150 micrometers. By way of example, each cell C1 to CN may have a square shape with sides of 100 micrometers.

As FIG. 6b shows a front view, the substrate 2 and the metal layer 3 are only partially visible. Alternatively, the substrate 2 and the metal layer 3 have the same length and width dimensions as the layer of electrochromic material 4, in which case the substrate 2 and the metal layer 3 are not visible in FIG. 6a.

Alternatively again, the cells C1 to CN are distinct layers of electrochromic material, arranged on substrates 2 and respective metal layers 3.

An example with 15 cells is shown in FIG. 6b, by way of illustration. However, the reflection assembly 10 can comprise more than one hundred cells, or even more than one thousand cells.

FIG. 6c shows a reflection assembly 10 of a device 5 according to a third embodiment of the invention.

In the third embodiment, the reflection assembly 10 comprises an array of K pixels, K being greater than or equal to 2, each pixel comprising M cells, M being greater than or equal to 2.

The layer of electrochromic material 4 is thus divided into M*K cells, M cells forming a pixel of an array of pixels.

In the example of FIG. 6c, M is equal to 9 and K is equal to 15. Consequently, N, the total number of cells, is equal to 9*15=135.

In the third embodiment, the color of each of the M pixels is obtained by synthesizing the colors of the K cells that make up the pixel. Greater richness is thus possible in the colors that can be achieved by each pixel compared to the second embodiment.

The resolution of the image formed is equal to M, with great variability in the colors obtained by synthesizing the colors of the K cells of each pixel.

Each cell of a pixel can be driven individually so as to reflect a light beam of a given color. Alternatively, multiple sets of cells of a pixel are driven set by set. For example, each set may be a row or a column of pixels.

There is no restriction attached to the dimensions of each pixel P1-PK, in particular to the width and the length of each cell P1 to PK, that is to say to the dimensions shown in the front view of FIG. 6c.

For example, each pixel may have a width and a length of between 50 and 500 micrometers, for example of between 50 and 200 micrometers, and in particular of between 70 and 150 micrometers. By way of example, each pixel P1 to PK may have a square shape with sides of 100 micrometers.

Furthermore, no restriction is attached to the dimensions of the cells in each pixel, in particular to the length and the width of each cell. Such dimensions depend on the number of cells per pixel and on the dimensions of the pixel. For example, each cell can have a length and a width of between 20 and 50 micrometers, in particular of between 30 and 40 micrometers.

An example of the third embodiment is described below, solely by way of illustration.

In this example, the nine cells of a given pixel can be driven by column. Thus, each column forms a set of cells whose color can be controlled by the electrical control circuit. Thus, the three columns can be driven separately, thereby allowing a color of the pixel to be synthesized from the respective colors of the three columns.

For example, taking the particular example of the fourth pixel P4, the first column comprises the cells C4,1; C4,4 and C4,7, the second column comprises the cells C4,2; C4,5 and C4,8 and the third column comprises the cells C4,3; C4,6 and C4,9.

Thus, when the three columns are red, the pixel is red. When the first column and the third column are blue and the second column is red, the pixel is violet. When the first column and the third column are red, and when the second column is green, the pixel is yellow, etc.

A method for controlling the image projection device described above is described below.

The electrical control circuit 15 can receive a setpoint. In the second and third embodiments, on the basis of which the electrical control circuit determines a set of voltages to be applied to the cells or sets of cells of the layer of electrochromic organic material 4. The set of voltages reflects the colored pattern forming the image that the user wishes to project. In the first embodiment, the electrical control circuit 15 determines the color of the single cell C, and optionally a mask pattern 9, on the basis of the setpoint.

Once the voltage or voltages have been applied to the cell or cells of the layer of electrochromic material 4, the luminous source 6 is turned on in order to emit the source beam FS, which is converted into the homogeneous beam FH by the optical luminous system 7. The multilayer structure S forming the image Im receives the homogeneous beam FH and reflects it toward the optical projection system 8. The optical projection system 8 projects the image 103 onto the ground.

What is claimed is:

1. An image projection device comprising:
a luminous source for emitting light rays,
an image formation module including a reflection assembly which is able to reflect light rays from the luminous source as a reflected beam,
an optical projection system which is placed in the path of the reflected beam and is able to project an image formed by the image formation module,
wherein the reflection assembly includes a multilayer structure including a substrate, a metal layer and a layer of electrochromic material including at least one cell which is encapsulated in an electrolyte layer and connected to a pair of electrodes, and
an electrical control circuit which is able to vary a voltage applied to the pair of electrodes so as to vary a color of the at least one cell.

2. The image projection device as claimed in claim 1, wherein the layer of electrochromic material includes a single cell and wherein the image formation module includes at least one mask positioned between the reflection assembly and the optical projection system, the mask being able to produce a pattern of the image formed by the image formation module.

3. The image projection device as claimed in claim 2, wherein the image formation module includes a set of multiple masks, and wherein the electrical control circuit is able to select one of the masks of the set for producing the pattern of the image formed by the image formation module.

4. The image projection device as claimed in claim 1, wherein the reflection assembly includes a plurality of pixels, each pixel being formed by at least one cell and being connected to at least one pair of electrodes, the electrical control circuit being able to independently vary the voltage applied to the at least one pair of electrodes of each pixel.

5. The image projection device as claimed in claim 4, wherein each pixel of the plurality of pixels has a length and a width of between 50 and 500 micrometer.

6. The image projection device as claimed in claim 4, wherein each pixel is formed by a single cell and is connected to a single pair of electrodes.

7. The image projection device as claimed in claim 4, wherein each pixel is formed by a plurality of cells and wherein, for each pixel, the plurality of cells includes at least a first set of at least one cell and a second set of at least one cell, the first set being connected to a first pair of electrodes and the second set being connected to a second pair of electrodes, and wherein the electrical control circuit is able to vary the color of each pixel by varying a first voltage of the first pair of electrodes and a second voltage of the second pair of electrodes.

8. The image projection device as claimed in claim 7, wherein, for each pixel, the first set includes multiple cells and the second set includes multiple cells.

9. The image projection device as claimed in claim 1, wherein the electrochromic material is chosen from PEDOT, PMMA or polycarbonate.

10. A method for controlling an image projection device, the image projection device including a luminous source for emitting light rays, an image formation module including a reflection assembly which is able to reflect light rays from the luminous source as a reflected beam, an optical projection system which is placed in the path of the reflected beam and is able to project an image formed by the image formation module, wherein the reflection assembly includes a multilayer structure including a substrate, a metal layer and a layer of electrochromic material including at least one cell which is encapsulated in an electrolyte layer and connected to a pair of electrodes so as to vary a color of the at least one cell, the method comprising:
receiving a setpoint by way of the electrical control circuit;
determining a voltage to be applied to each pair of electrodes on the basis of the setpoint;
applying, for each pair of electrodes, the voltage by way of the electrical control circuit.

11. The image projection device as claimed in claim 4, wherein each pixel of the plurality of pixels has a length and a width of between 70 and 150 micrometers.
